(19) United States
(12) Patent Application Publication
(10) Pub. No.: US 2003/0230530 A1
(43) Pub. Date: Dec. 18, 2003

(54) Process for the preparation of a combination of Famotidine Polymorphs A and B

(75) Inventors: Mandayam Chakravarthy Sriraman, Vadodara (IN); Jignesh Harikesh Vyas, Vadodara (IN); Janardhan Prasad Sanyal, Vadodara (IN); Mahesh Natwarlal Shah, Vadodara (IN); Yogen Talia, Vadodara (IN)

Correspondence Address: John S. Egbert, Harrison & Egbert, 7th Floor, 412 Main Street, Houston, TX, 77002, US

(73) Assignee: M/S. TONIRA PHARMA LIMITED, Vadodara (IN)

(21) Appl. No.: 10/424,587

(22) Filed: Apr. 28, 2003

(30) Foreign Application Priority Data
May 2, 2002 (IN) 394/MUM/2002
May 2, 2002 (IN) 395/MUM/2002

(51) Int. Cl. B01D 11/04

(52) U.S. Cl. 210/634; 210/639; 210/770; 210/774; 210/806

(57) ABSTRACT

A process for the preparation of a combination of Famotidine [Chemical Name (N-Sulfamyl-3-(2-guanidinothiazole-4-yl-methylthio) proionamidine] Polymorphs A and B comprising the following steps: dissolving Famotidine crude in solvent such as methanol under heating and stirring to form a solution; adding activated carbon to the solution of step (a) at 45° C. for 30 minutes; filtering the solution of step (a) to obtain a clear colorless solution; concentrating the solution under vacuum at a temperature of 45° C. to 58° C. under vacuum to get a crystalline slurry; filtering out the crystals of Famotidine Polymorphs A and B combination; drying the said crystals of Famotidine Polymorphs A and B combination in an oven.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to “A process for the preparation of a combination of Famotidine Polymorphs A and B”. Famotidine [chemical name is N-Sulfamyl-3-(2-guanidinothiazole-4-yl-methylthio) proionamidine].

### BACKGROUND OF THE INVENTION

Famotidine is a competitive inhibitor of histamine H2-receptors. The primary clinically important pharmacological activity of Famotidine is inhibition of gastric secretion. Famotidine suppresses both the acid concentration and volume of gastric secretion, while changes in pepsin secretion are proportional to volume output.

There are two polymorphs of Famotidine reported as Polymorph “A” and Polymorph “B” and their manufacturing process has been reported by M/s. Richter Gedeon, Hungary in the U.S. Pat. No. 4,894,459 (Jan. 16, 1990), U.S. Pat. No. 5,120,850 (Jun. 9 1992), U.S. Pat. No. 5,128,477 (Jul. 7 1992), Canadian Patent 1265809 (Feb 13, 1990), European Patent EP 256747 (Nov, 11, 1992) and Japanese Patent 7316141 (Feb 24, 1988). The Famotidine Polymorph “A” and Famotidine Polymorph “B” differ in their I.R Spectra, Differential Scanning Calorimetry (DSC) Measurement Data, X-Ray Diffraction Data and Solubility data.

The process for the preparation of the individual Famotidine Polymorph “A” and Polymorph “B”, use a crystallization method from water or water-alcohol mixtures, with a varying rate of cooling as described in the above referred prior art Patents.

Polymorph A of Famotidine is more stable and is having low dissolution properties, while Famotidine Polymorph B is metastable and is having higher dissolution properties.

### BRIEF SUMMARY OF THE INVENTION

According to a first aspect of the invention, there is provided a process for the preparation of a combination of Famotidine [Chemical Name (N-Sulfamyl-3-(2-guanidinothiazole-4-yl-niethylthio) proionamidine] Polymorphs A and B comprising the following steps:

a) dissolving Famotidine crude in solvent/methanol under heating and stirring to form a solution;

b) filtering the solution of step (a) to obtain a clear colourless solution;

c) cooling the said solution of step (b) with ice and salt mixture under agitation;

d) seeding the said cooled solution of step (c) with a mixture of Famotidine Polymorph A and Famotidine Polymorph B for crystallisation; and

e) filtering out the crystals of Famotidine Polymorphs A and B combination, drying the said crystals of Famotidine Polymorphs A and B combination in an oven.

According to a second aspect of the invention, there is provided a process for the preparation of a combination of Famotidine [Chemical Name (N-Sulfamyl-3-(2-guanidinothiazole-4-yl-methylthio) proionamidine] Polymorphs A and B comprising the following steps:

a) dissolving Famotidine crude in solvent such as methanol under heating and stirring to form a solution;

b) adding activated carbon to the solution of step (a) at 45° C. for 30 minutes;

c) filtering the solution of step (a) to obtain a clear colourless solution;

d) concentrating the solution under vacuum at a temperature of 45° C. to 58° C. under vacuum to get a crystalline slurry;

e) filtering out the crystals of Famotidine Polymorphs A and B combination; and

f) drying the said crystals of Famotidine Polymorphs A and B combination in an oven.

According to a third aspect of the invention, there is provided a process for the preparation of a combination of Famotidine [Chemical Name (N-Sulfamyl-3-(2-guanidinothiazole-4-yl-methylthio) proionamidine] Polymorphs A and B comprising the following steps:

a) suspending Famotidine crude in solvent such as methanol under heating and stirring and reacting with concentrated Hydrochloric acid to give Famotidine Hydrochloride;

b) dissolving the Famotidine Hydrochloride in solvent such as methanol;

c) adding activated carbon to the solution of step (b) at 45° C. to 58° C. for 30 minutes;

d) filtering the solution of step (c) to obtain a clear colourless solution;

e) making the solution of step (d) basic with triethylamine;

f) concentrating the solution of step (e) under vacuum at a temperature around 45° C. to 58° C. to give a crystalline slurry;

g) filtering out the crystals of Famotidine Polymorphs A and B combination; and

h) drying the said crystals of Famotidine Polymorphs A and B combination in an oven.

### BRIEF DESCRIPTION OF THE SEVERAL VIEWS OF THE DRAWINGS

FIG. 1 is a graphic illustration of DSC analysis showing Famotidine pure polymorph A.

FIG. 2 is a graphic illustration of DSC analysis showing Famotidine pure polymorph B.

FIG. 3 is a graphic illustration of the DSC analysis indicating a combination of Famotidine polymorph A and polymorph B in a specific ratio of 22:78.

FIG. 4 is a graphic illustration of the DSC analysis indicating a combination of Famotidine polymorph A and polymorph B in a specific ratio of 35:65.

FIG. 5 is a graphic illustration of the DSC analysis indicating a combination of Famotidine polymorph A and polymorph B in a specific ratio of 15:85.

FIG. 6 is a graphic illustration of the DSC analysis indicating a combination of Famotidine polymorph A and polymorph B in a specific ratio of 05:95

FIG. 7 is a graphic illustration of the DSC analysis indicating a combination of Famotidine polymorph A and polymorph B in a specific ratio of 27:73.

FIG. 8 is a graphic illustration of the DSC analysis indicating a combination of Famotidine polymorph A and polymorph B in a specific ratio of 42:58.

### DETAILED DESCRIPTION OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

The co-pending Patent Application No. 1156/MUM/2001 Dated Dec. 6, 2001 describes “A process for the preparation of a combination of Famotidine Polymorphs A and B” The Process described in the said Patent Application No. 1156/MUM/2001, Famotidine (Crude) is dissolved in the solvent/Methanol and the solution is cooled in ice and salt mixture with seeding to give a mixture of Famotidine Polymorph “A” and Famotidine Polymorph “B” wherein the ratio of Polymorph “A” to Polymorph “B” in the combination of Famotidine Polymorph varies from 15:85 to 35:65.

The main object of this invention is to provide “A process for the preparation of a combination of Famotidine Polymorphs A and B” whereby the dissolving rates can be controlled and the desired solubility properties of the Famotidine can be achieved.

Another object of this invention is to provide “A process for the preparation of a combination of Famotidine Polymorphs A and B” wherein Polymorph A and Polymorph B are in a specific ratio as desired (for example, A:B 5:95 to 40:60 combinations).

Accordingly this invention provides a process for the preparation of a combination of Famotidine [Chemical Name (N-Sulfamyl-3-(2-guanidinothiazole-4-yl-methylthio) proionamidine] Polymorphs A and B comprising the following steps:

Dissolving Famotidine crude in solvent/methanol under heating and stirring to form a solution,

Filtering the solution of step (a) to obtain a clear colourless solution;

Cooling the said solution of step (b) with ice and salt mixture under agitation;

Seeding the said cooled solution of step (c) with a mixture of Famotidine Polymorph A and Famotidine Polymorph B for crystallization,

Filtering out the crystals of Famotidine Polymorphs A and B combination;

Drying the said crystals of Famotidine Polymorphs A and B combination in an oven.

Wherein the crude Famotidine is prepared by an organic synthetic process;

Wherein Famotidine (crude) to solvent/methanol ratio Is 1:50 to 1.70;

Wherein the Famotidine methanol solution of step (a) in claim 1 is treated with activated carbon;

Wherein the Famotidine methanol solution of step (a) in claim 1 is heated to a boiling point of 60 to 75 degrees centigrade;

Wherein the Famotidine methanol solution is filtered in Buchner funnel for obtaining clear colorless solution;

Wherein clear colorless solution of step (b) of claim 1 is cooled by ice and salt mixture to a temperature of 15 to 25 degrees centigrade;

Wherein the seeding mixture of Famotidine Polymorph A and Famotidine Polymorph B is in a ratio of 20:80 to 50:50;

Wherein the crystals of Famotidine Polymorphs A and B combination in step (e) are dried in an oven at a temperature of 50 to 60 degrees centigrade;

Wherein the ratio of Polymorph A to Polymorph B in the combination of Famotidine Polymorphs varies from 15:85 to 35:65;

In “A process for the preparation of a combination of Famotidine Polymorphs A and B”, according to this invention the starting material is Famotidine (crude), which is manufactured by a synthetic process, having the total impurities and hence not suited for the use as a Pharmaceutical product. The crude Famotidine is dissolved in pure Methanol in the ratio of 50 to 70 times by volume to Famotidine (crude) and crystallized by cooling in ice-salt mixture, followed by seeding at specific temperature to get the desired Polymorph A and B ratio. The seeding used is prepared by a specific process, wherein a Polymorphs mixture is obtained.

Accordingly this invention provides a process based on evaporative crystallization for the preparation of a combination of Famotidine [Chemical Name (N-Sulfamyl-3-(2-guanidinothiazole-4-yl-methylthio) proionamidine] Polymorphs A and B comprising the following steps:

(a) dissolving Famotidine(crude) in solvent such as methanol under heating and stirring to form a solution;

(b) adding Activated Carbon to the solution of step (a);

(c) maintaining the above solution of step (b) at 45° C. to 58° C. for 30 minutes;

(d) filtering the solution of step (c) to give a clear and colourless solution;

(e) transferring the solution obtained under step (d) to another container and distilling out the solvent such as methanol under vacuum at a temperature of 45° C. to 58° C. under vacuum;

(f) distilling out 33% to 90% of the solvent such as methanol under the conditions of Step (e) to get a crystalline slurry, which is a combination of Famotidine Polymorph “A” and Famotidine Polymorph “B”;

(g) filtering the crystalline slurry of step (f) to give the wet crystalline product, which is dried at 60° C. to give a combination of Famotidine Polymorphs “A” and Famotidine Polymorph “B”.

wherein the crude Famotidine is prepared by an organic synthetic process;

wherein Famotidine (crude) to solvent such as methanol ratio is 1:50 to 1:70;

wherein the Famotidine methanol solution of the above step (a) is treated with activated carbon;

wherein the Famotidine methanol solution with Activated Carbon is filtered in Buchner funnel for clear colorless solution;

wherein clear colorless solution of the above step (d) is concentrated under vacuum to effect an evaporative crystallization at a temperature of 45° C. to 58° C. and a vacuum;

wherein the quantity of distilled solvent ranging from 33% to 90% by volume. A crystalline slurry of the combination of Famotidine Polymorph “A” and Famotiidine Polymorph “B” is obtained which is filtered in a Buchner Funnel.

wherein the crystals of Famotidine Polymorphs A and B combination in the above step (e) are dried in an oven at a temperature of 50 to 60 degrees centigrade(° C.).

wherein the ratio of Polymorph A to Polymorph B in the combination of Famotidine Polymorphs is specific and varies from 05:95 to 40:60 as desired.

In the process for the preparation of a combination of Famotidine Polymorphs A and B, according to this invention the starting material is Famotidine (crude), which is manufactured by a synthetic process, having different impurities and hence not suited for the use as a Pharmaceutical product. The crude Famotidine is dissolved in pure Methanol in the ratio of 50 to 70 times by volume to Famotidine (crude) and concentrated by evaporative crystallization (Distilation of solvent such as methanol by heating under vacuum) at a temperature ranging from 45° C. to 58° C. under vacuum to give a combination of Famotidine Polymorph “A” and Famotidine Polymorph “B”.

Accordingly this invention provides a process based on evaporative crystallization for the preparation of a combination of Famotidine [Chemical Name (N-Sulfamyl-3-(2-guanidinothiazole-4-yl-methylthio) proionamidine] Polymorphs A and B comprising the following steps:

(a) Dissolving Famotidine crude in solvent such as methanol under heating and stirring with of Hydrochloric acid to give Famotidine Hydrochloride, which is filtered.

(b) The Famotidine hydrochloride dissolved in solvent such as methanol by heating to give a Solution.

(c) Activated Carbon is added to the solution (b). It is maintained at 45° C. to 58° C. for 30 minutes.

(d) It is filtered in a Buchner funnel to give a clear colourless solution.

(e) The Famotidine hydrochloride solution made basic with triethylamine to give a clear colourless solution.

(f) Distilling out the methanol by heating under vacuum at 45° C. to 58° C., the distillate volume ranging from 33% to 90% to give a crystalline slurry of combination of Famotidine Polymorph“A” and Famotidine Polymorph “B”.

(g) Filtering out the wet crystals of Famotidine Polymorphs A and B combination;

(h) Drying the said crystals of Famotidine Polymorphs A and B combination in an oven.

wherein the crude Famotidine is prepared by an organic synthetic process;

wherein Famotidine is converted to Famotidine Hydrochloride by reacting with Concentrated Hydrochloric acid in solvent such as methanol solution.

wherein the crystalline Famotidine Hydrochloride filtered in a Buchner funnel.

wherein the Famotidine Hydrochloride is dissolved in Solvent such as methanol

wherein Famotidine hydrochloride to solvent such as methanol ratio is 1:50 to 1:70;

wherein the Famotidine hydrochloride in methanol solution of the above step (b) is treated with activated carbon.

wherein the Famotidine hydrochloride in methanol solution of step (c) is maintained at 45° C. to 58° C. for 30 minutes.

wherein the Famotidine-methanol solution with Activated carbon is filtered in Buchner funnel for clear colourless solution;

wherein clear colourless solution of the above step (e) is made basic with Triethylamine and concentrated under vacuum to effect an evaporative crystallization (Distillation of Solvent/methanol by heating under vacuum) at a temperature 0f 45° C. to 58° C. under vacuum.

wherein the quantity of distilled solvent ranging from 33% to 90% by volume.

A crystalline slurry of the combination of Famotidine Polymorph “A” and Famotidine Polymorph “B” is obtained which is filtered in a Buchner Funnel.

wherein the crystals of Famotidine Polymorphs A and B combination in step (f) are dried in an oven at a temperature of 50 to 60 degrees centigrade;

wherein the ratio of Polymorph A to Polymorph B in the combination of Famotidine Polymorphs varies from 05:95 to 40:60;

In the process for the preparation of a combination of Famotidine Polymorphs A and B, according to this invention the starting material is Famotidine (crude), which is manufactured by a synthetic process, having different impurities and hence not suited for the use as a Pharmaceutical product. The crude Famotidine is treated with Hydrochloric acid in pure Methanol to give Famotidine Hydrochloride. Famotidine Hydrochloride is dissolved solvent such as methanol in the ratio of 50 to 70 times by volume to Famotidine hydrochloride to give a clear solution, which was Activated carbon treated to give a solution of Famotidine hydrochloride in methanol. The above said solution is made basic by adding Triethylamine and concentrated by evaporative crystallization at a temperature ranging from 45° C. to 58° C. under vacuum. to give a combination Famotidine Polymorph A and Famotidine Polymorph B.

Table 1 illustrates the nature of polymorph obtained by different crystallization process. In order to determine the ratio of Polymorph “A” and Polymorph “B”, the Differential Scanning Calorimetry technique (DSC analysis) was found to be the best method in our opinion and this data is taken in our all experiments. It is clarified that the other techniques like solubility determination, IR Spectra and X-ray diffraction will not be able to determine the, ratio of the individual polymorphs.

TABLE 1

| | Famotidine | | Ratio (Wt: | Dissolution | Cooling/ | Polymorph |
|---|---|---|---|---|---|---|
| No. | crude | Solvent | Volume) | Temperature | Seeding | Ratio |
| 1 | 50 g | Methanol | 1:55 | 65° C. | Cooling/ | Polymorph |
| Water | ″A″ | | | | | |
| 2 | 50 g | Methanol | 1:55 | 65° C. | Ice + Salt | Polymorph |
| | | | | | Mixture | ″B″ |
| 3 | 50 g | Methanol | 1:55 | 65° C. | Ice + Salt | Polymorph |
| | | | | | Mixture | ″A″ 22% |
| | | | | | Seeding | Polymorph |
| | | | | | At 20° C. | ″B″ 65% |
| | | | | | Ratio | |
| | | | | | 20:80 | |
| 4 | 50 g | Methanol | 1:60 | 65° C. | Ice + Salt | Polymorph |
| | | | | | Mixture | ″A″ 35% |
| | | | | | Seeding | Polymorph |
| | | | | | At 25° C. | ″B″ 65% |
| | | | | | Ratio | |
| | | | | | 20:80 | |
| 5 | 50 g | Methanol | 1:60 | 65° C. | Ice + Salt | Polymorph |
| | | | | | Mixture | ″A″ 15% |
| | | | | | Seeding | Polymorph |
| | | | | | At 15° C. | ″B″85% |
| | | | | | Ratio | |
| | | | | | 50:50 | |

Table 2 illustrates the nature of polymorph obtained by different crystallization process. In order to determine the ratio of Polymorph “A” and Polymorph “B”, the Differential Scanning Calorimetry technique (DSC analysis) was found to be the best method in our opinion and this data is taken in our all experiments. It is clarified that the other techniques like solubility determination, IR Spectra and X-ray diffraction will not be able to determine the ratio of the individual polymorphs.

TABLE 2

| | Famotidine | | Ratio | Crystallisation | Polymorph |
|---|---|---|---|---|---|
| No. | (Crude) | Solvent | (Wt: Volume) | Method | Ratio |
| 1. | 50 g | Methanol | 1:55 | Cooling water | Polymorph ″A″ |
| 2. | 50 g | Methanol | 1:55 | Ice + Salt | Polymorph ″B″ |
| | | | | mixture | |
| 3. | 50 g | Methanol | 1:55 | Evaporative | Polymorph ″A″ |
| | | | | crystallization | 05% Polymorph |
| | | | | 333% solvent | ″B″ 95% |
| | | | | distilled out | |
| 4. | 50 g | Methanol | 1:60 | Evaporative | Polymorph ″A″ |
| | | | | Crystallisation | 27% Polymorph |
| | | | | method | ″B″ 73% |
| | | | | 90% solvent | |
| | | | | distilled out | |

Table 3 illustrates the nature of polymorph obtained by different crystallization process. In order to determine the ratio of Polymorph “A” and Polymorph “B”, the Differential Scanning Calorimetry technique (DSC analysis) was found to be the best method in our opinion and this data is taken in our all experiments. It is clarified that the other techniques like solubility determination, I R Spectra and X-ray diffraction will not be able to determine the ratio of the individual polymorphs.

TABLE 3

| | Famotidine | | Ratio | Crystallisation | Polymorph |
|---|---|---|---|---|---|
| No. | Crude | Solvent | (Wt: Volume) | Method | Ratio |
| 1 | 50 g | Methanol | 1:55 | Cooling water | Polymorph ″A″ |
| 2. | 50 g | Methanol | 1:55 | Ice + Salt | Polymorph ″B″ |
| | | | | mixture | |
| 3. | 50 g | Methanol | 1:55 | Evaporative | Polymorph ″A″ |
| | | | | crystallization | 05% Polymorph |
| | | | | 333% solvent | ″B″ 95% |
| | | | | distilled out | |
| 4. | 50 g | Methanol | 1:60 | Evaporative | Polymorph ″A″ |
| | | | | Crystallisation | 27% Polymorph |
| | | | | method | ″B″ 73% |
| | | | | 90% solvent | |
| | | | | distilled out | |
| 5. | 50 g | Methanol | 1:60 | Evaporative | Polymorph ″A″ |
| | (Famotidine | | | crystatlisation | 42% Polymorph |
| | Hydrochloride) | | | | ″B″ 58% |

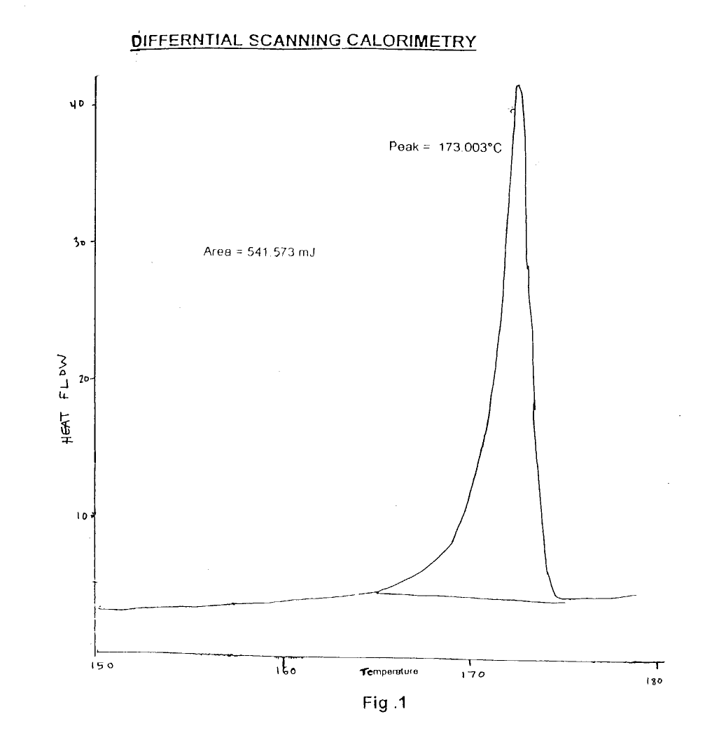

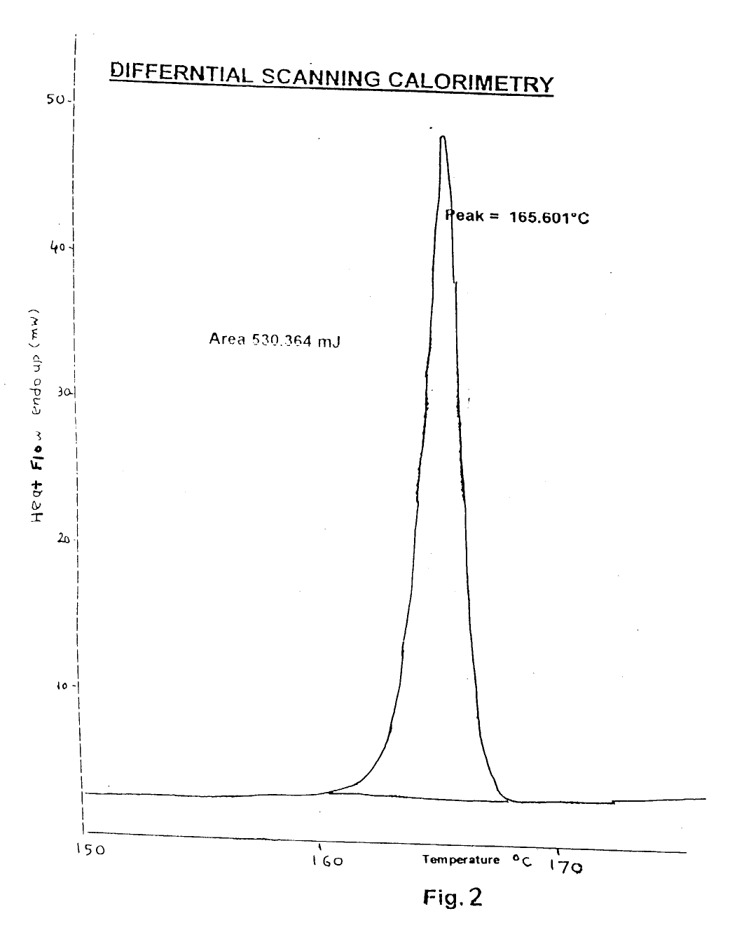

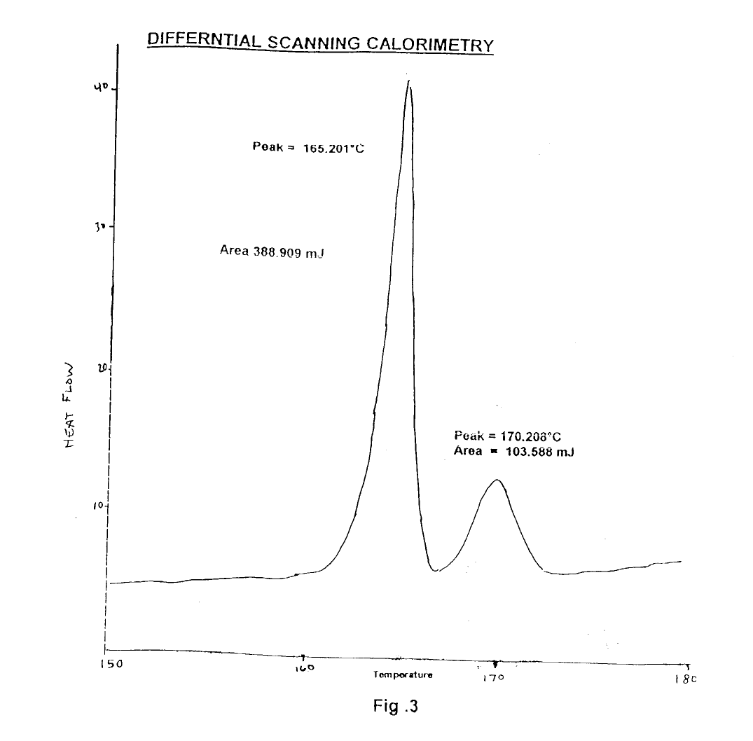

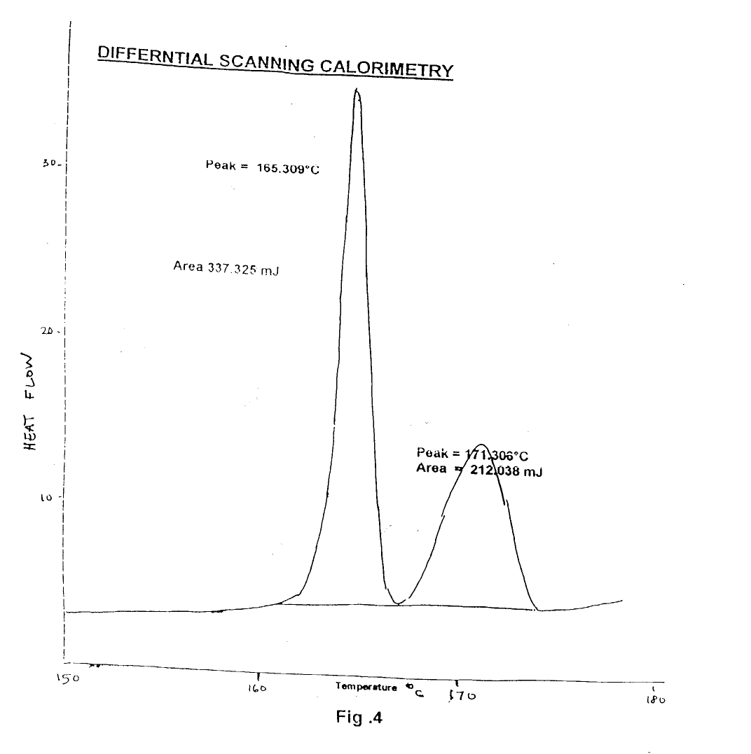

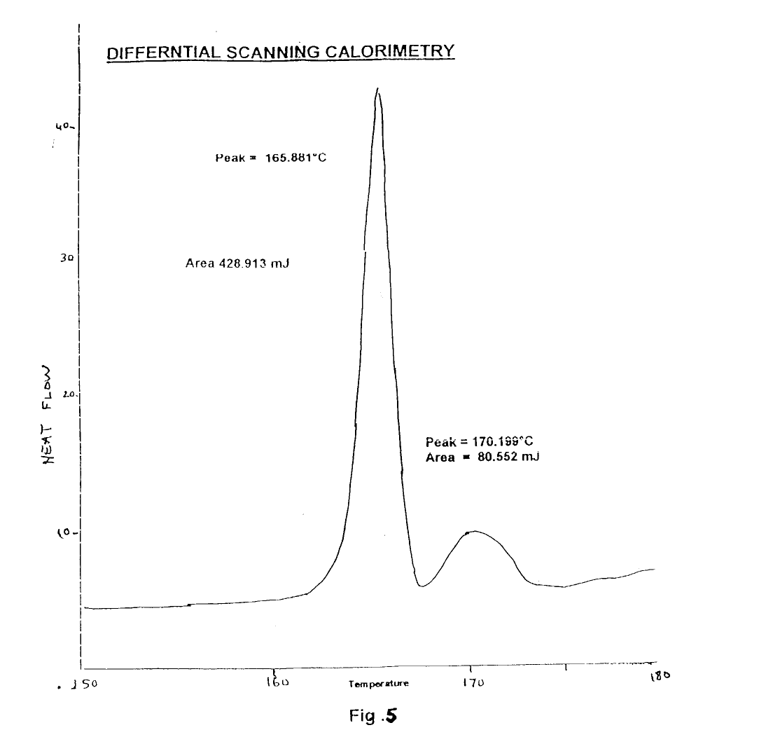

The following examples are illustrated of the process of preparation of Famotidine pure polymorph A (of FIG. 1), Famotidine pure polymorph B (of FIG. 2) and a combination of Famotidine polymorph A and B (according to this invention) in a specific ratio of 13:87 of FIG. 3, a combination of Famotidine polymorph A and B (according to this invention) in a specific ratio of 27:73 of FIG. 4, a combination of Famotidine polymorph A and B (according to this invention) in a specific ratio of 42:58 of FIG. 5.

### EXAMPLE 1

In a 3000 ml, three necked round bottomed flask, equipped with a stirrer, thermometer and a reflux condenser, placed on a water bath, Methanol (2750 ml) is taken and Famotidine (crude) (50 g) is added into it. The mixture is heated to boiling point (75° C.) and all the Famotidine is dissolved to give a solution. Activated carbon (20 g) is added into it and mixed well for 30 minutes. It is then filtered in a Buchner funnel to give a clear colorless solution. The solution is immediately transferred to another 3000 ml, three necked round bottom flask, equipped with a stirrer, thermometer and cooled under agitation with cooling water. The temperature dropped to 25° C. in about 2 hours time and it was cooled in ice+salt mixture to 0° C. The crystals of Famotidine thus obtained was filtered and dried in oven at 60° C.

The DSC analysis indicate it to be Famotidine Polymorph “A” Pure (FIG. 1)

### EXAMPLE 2

In a 3000 ml, three necked round bottomed flask, equipped with a stirrer, thermometer and a reflux condenser, placed on a water bath, Methanol (2750 ml) is taken and Famotidine (crude) (50 g) is added into it. The mixture is heated to boiling point (75° C.) and all the Famotidine is dissolved to give a solution. Activated carbon (20 g) is added into it and mixed well for 30 minutes. It is then filtered in a Buchner funnel to give a clear colorless solution. The solution is immediately transferred to another 3000 ml, three necked round bottomed flask, equipped with a stirrer, thermometer and cooled under agitation with Ice+Salt mixture. The temperature dropped to 0° C. in about 1 hour. The crystals of Famotidine thus obtained was filtered and dried in oven at 60° C.

The DSC analysis indicate it to be Famotidine Polymorph “B” Pure (FIG. 2)

### EXAMPLE 3

In a 3000 ml, three necked bottomed flask, equipped with a stirrer, thermometer and a reflux condenser, placed on a water bath, Methanol (2750 ml) is taken and Famotidine (crude) (50 g) is added into it. The mixture is heated to boiling point (75° C.) and all the Famotidine is dissolved to give a solution. Activated carbon (20 g) is added into it and mixed well for 30 minutes. It is then filtered in a Buchner funnel to give a clear colorless solution. The solution is immediately transferred to another 3000 ml, three necked round bottomed flask, equipped with a stirrer, thermometer and cooled under agitation with Ice+Salt mixture. The temperature dropped to 20° C. in about 1 hour and it was seeded with a mixture of Famotidine polymorphs A:B (20:80). The crystals of Famotidine thus obtained was filtered and dried in oven at 55° C.

The DSC analysis indicate it to be a mixture of Famotidine Polymorph “A” and Famotidine Polymorph “B” (22:78) (FIG. 3)

### EXAMPLE 4

In a 3000 ml, three necked bottomed flask, equipped with a stirrer, thermometer and a reflux condenser, placed on a water bath, Methanol (2750 ml) is taken and Famotidine (crude) (50 g) is added into it. The mixture is heated to boiling point (75° C.) and all the Famotidine is dissolved to give a solution. Activated carbon (20 g) is added into it and mixed well for 30 minutes. It is then filtered in a Buchner funnel to give a clear colorless solution. The solution is immediately transferred to another 3000 ml, three necked round bottomed flask, equipped with a stirrer, thermometer and cooled under agitation with Ice+Salt mixture. The temperature dropped to 25° C. in about 1 hour and it was seeded with a. mixture of Famotidine polymorphs A:B (20:80). The crystals of Famotidine thus obtained was filtered and dried in oven at 55° C.

The DSC analysis indicate it to be a mixture of Famotidine Polymorph “A” and Famotidine Polymorph “B” (35:65) (FIG. 4)

### EXAMPLE 5

In a 3000 ml, three necked bottomed flask, equipped with a stirrer, thermometer and a reflux condenser, placed on a water bath, Methanol (2750 ml) is taken and Famotidine (crude) (50 g) is added into it. The mixture is heated to boiling point (75° C.) and all the Famotidine is dissolved to give a solution, Activated carbon (20 g) is added into it and mixed well for 30 minutes, It is then filtered in a Buchner funnel to give a clear colorless solution. The solution is immediately transferred to another 3000 ml, three necked round bottomed flask, equipped with a stirrer, thermometer and cooled under agitation with. Ice+Salt mixture. The temperature dropped to 25° C. in about 1 hour and it was seeded with a mixture of Famotidine polymorphs A:B (50:50). The crystals of Famotidine thus obtained was filtered and dried in oven at 55° C.

The DSC analysis indicate it to be a mixture of Famotidine Polymorph “A” and Famotidine Polymorph “B” (15:85) (FIG. 5).

### EXAMPLE 6

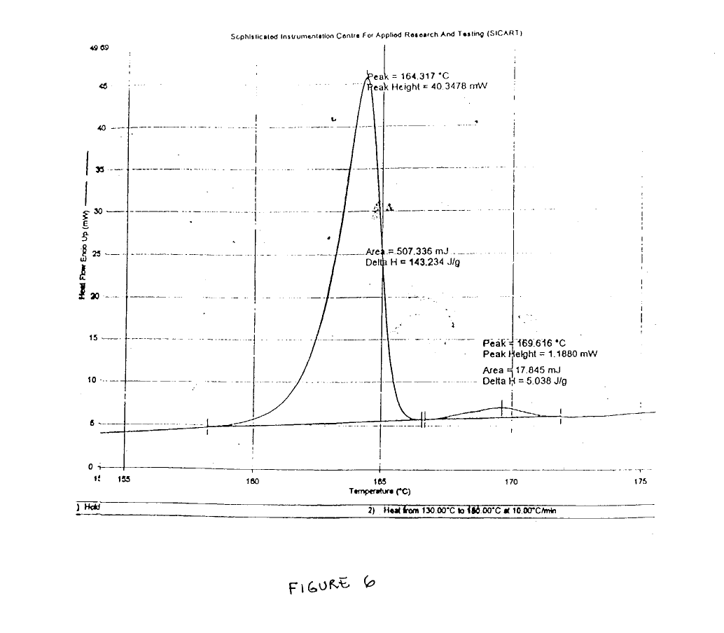

In a 3000 ml, three necked bottomed flask, equipped with a stirrer, thermometer and a reflux condenser, placed on a water bath, Methanol (2750 ml) is taken and Famotidine (crude) (50 g) is added into it. The mixture is heated to dissolve and all the Famotidine is dissolved to give a solution. Activated carbon (20 g) is added into it and mixed well for 30 minutes at 45° C. It is then filtered in a Buchner funnel to give a clear colorless solution. The solution is immediately transferred to another 3000 ml, three necked round bottomed flask, equipped with a stirrer, thermometer and concentrated under vacuum at 45-58° C. to effect Evaporative crystallization. After distilling about 33% of the solvent, a crystalline slurry was obtained, which was filtered at 45° C. The crystals of combination of Famotidine polymorph“A” and Famotidine Polymorph “B”. Famotidine, thus obtained was dried in oven at 60° C. (DSC analysis: FIG. 6)

The DSC analysis indicate it to be a mixture of Famotidine Polymorph “A” and Famotidine Polymorph “B” (05:95) (FIG. 6).

### EXAMPLE 7

In a 3000 ml, three necked bottomed flask, equipped with a stirrer, thermometer and a reflux condenser, placed on a water bath, Methanol (2750 ml) is taken and Famotidine (crude) (50 g) is added into it. The mixture is heated to dissolve and all the Famotidine is dissolved to give a solution. Activated carbon (20 g) is added into it and mixed well for 30 minutes at 45° C. It is then filtered in a Buchner funnel to give a clear colorless solution. The solution is immediately transferred to another 3000 ml, three necked round bottomed flask, equipped with a stirrer, thermometer and concentrated under vacuum at 45-58° C. to effect Evaporative crystallization. After distilling about 90% of the solvent, a crystalline slurry was obtained, which was filtered at 45° C. The crystals of combination of Famotidine polymorphs“A” and “B” Famotidine thus obtained was dried in oven at 60° C.

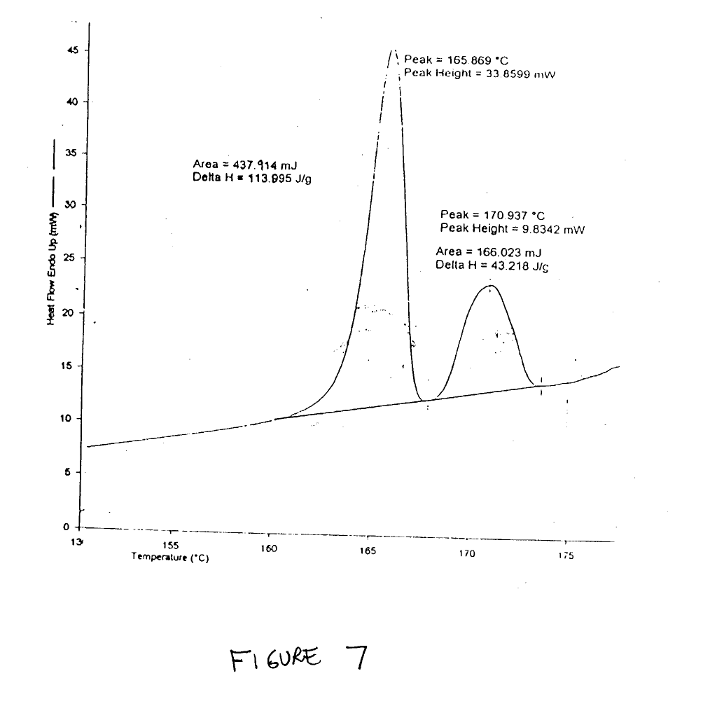

The DSC analysis indicate it to be a mixture of Famotidine Polymorph “A” and Famotidine Polymorph “B” (27:73) (FIG. 7).

### EXAMPLE 8

In a 3000 ml, three necked bottomed flask, equipped with a stirrer, thermometer and a reflux condenser, placed on a water bath, Methanol (500 ml) is taken and Famotidine (crude) (50 g) is added into it. Hydrochloric acid was added and this mixture was heated to 40° C. to precipitate the Famotidine hydrochloride. The Famotidine Hydrochloride thus obtained was filtered in a Buchner funnel. The Famotidine Hydrochloride and Methanol 2750 ml were heated to dissolve and all the Famotidine hydrochloride is dissolved to give a solution. Activated carbon (20 g) is added into it and mixed well for 30 minutes at 45° C. It is then filtered in a Buchner funnel to give a clear colorless solution. The solution is immediately transferred to another 3000 ml, three necked round bottomed flask, equipped with a stirrer, thermometer and made basic using Triethylamine (60 ml) concentrated under vacuum to effect evaporative crystallization, at 45-58° C. After distilling about 70% of the solvent methanol, a crystalline slurry was obtained, which was filtered in a Buchner funnel. The crystals of Famotidine thus obtained was filtered and dried in oven at 60° C.

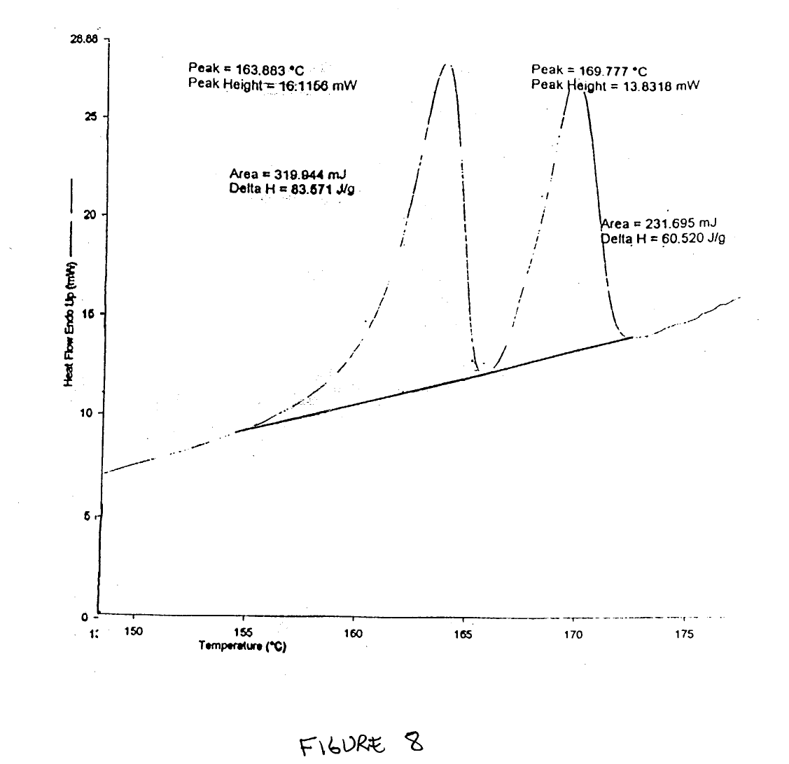

The DSC analysis indicate it to be a mixture of Famotidine Polymorph “A” and Famotidine Polymorph “B” (42:58) (FIG. 8).

While the preferred embodiments of the invention have been described above, it will be recognized and understood that various modifications may be made therein, and the appended claims are intended to cover all such modifications which may fall within the spirit and scope of the invention.

We claim:

1. A process for the preparation of a combination of Famotidine [Chemical Name (N-Sulfamyl-3-(2-guanidinothiazole-4-yl-niethylthio) proionamidine] Polymorphs A and B comprising the following steps:
a) dissolving Famotidine crude in solvent/methanol under heating and stirring to form a solution;
b) filtering the solution of step (a) to obtain a clear colourless solution;
c) cooling the said solution of step (b) with ice and salt mixture under agitation;
d) seeding the said cooled solution of step (c) with a mixture of Famotidine Polymorph A and Famotidine Polymorph B for crystallisation; and
e) filtering out the crystals of Famotidine Polymorphs A and B combination. drying the said crystals of Famotidine Polymorphs A and B combination in an oven.

2. The process as claimed in claim 1, wherein the crude Famotidine is prepared by an organic synthetic process.

3. The process as claimed in claim 1, wherein Famotidine (crude) to solvent/methanol ratio is 1:50 to 1:70.

4. The process as claimed in claim 1, wherein the Famotidine methanol solution of step (a) in claim 1 is treated with activated carbon.

5. The process as claimed in claim 1, wherein the Famotidine methanol solution of step (a) in claim 1 is heated to a boiling point of 60 to 75 degrees centigrade.

6. The process as claimed in claim 1, wherein the Famotidine methanol solution is filtered in Buchner funnel for obtaining clear colourless solution.

7. The process as claimed in claim 1, wherein clear colourless solution of step (b) of claim 1 is cooled by ice and salt mixture to a temperature of 15 to 25 degrees centigrade.

8. The process as claimed in claim 1, wherein the, seeding mixture of Famotidine Polymorph A and Famotidine Polymorph B is in a ratio of 20:80 to 50:50.

9. The process as claimed in claim 1, wherein the crystals of Famotidine Polymorphs A and B combination in step (e) are dried in ail oven at a temperature of 50 to 60 degrees centigrade.

10. The process as claimed in claim 1, wherein the ratio of Polymorph A to Polymorph B in the combination of Famotidine Polymorphs varies from 15:85 to 35:65.

11. A process for the preparation of a combination of Famotidine [Chemical Name (N-Sulfamyl-3-(2-guanidinothiazole-4-yl-methylthio) proionamidine] Polymorphs A and B comprising the following steps:
a) dissolving Famotidine crude in solvent such as methanol under heating and stirring to form a solution;
b) adding activated carbon to the solution of step (a) at 45° C. for 30 minutes;
c) filtering the solution of step (a) to obtain a clear colourless solution;
d) concentrating the solution under vacuum at a temperature of 45° C. to 58° C. under vacuum to get a crystalline slurry;
e) filtering out the crystals of Famotidine Polymorphs A and B combination; and
f) drying the said crystals of Famotidine Polymorphs A and B combination in an oven.

12. The process as claimed in claim 11, wherein the crude Famotidine is prepared by an organic synthetic process.

13. The process as claimed in claim 11, wherein Famotidine (crude) to solvent such as methanol ratio is 1:50 to 1:70.

14. The process as claimed in claim 11, wherein the Famotidine methanol solution is filtered in Buchner funnel for obtaining clear colorless solution.

15. The process as claimed in claim 11, wherein clear colourless solution of step (b) of claim 1 is concentrated under vacuum at a temperature around 45° C. to 55° C. to give a crystalline slurry.

16. The process as claimed in claim 11, wherein the crystals of Famotidine Polymorphs A and B combination in step (e) are dried in an oven at a temperature of 50 to 60 degrees centigrade.

17. The process as claimed in claim 11, wherein the ratio of Polymorph A to Polymorph B in the combination of Famotidine Polymorphs varies from 05:95 to 40:60.

18. A process for the preparation of a combination of Famotidine [Chemical Name (N-Sulfamyl-3-(2-guanidinothiazole-4-yl-methylthio) proionamidine] Polymorphs A and B comprising the following steps:
a) suspending Famotidine crude in solvent such as methanol under heating and stirring and reacting with concentrated Hydrochloric acid to give Famotidine Hydrochloride;
b) dissolving the Famotidine Hydrochloride in solvent such as methanol;
c) adding activated carbon to the solution of step (b) at 45° C. to 58° C. for 30 minutes;
d) filtering the solution of step (c) to obtain a clear colourless solution;
e) making the solution of step (d) basic with triethylamine;
f) concentrating the solution of step (e) under vacuum at a temperature around 45° C. to 58° C. to give a crystalline slurry;
g) filtering out the crystals of Famotidine Polymorphs A and B combination; and
h) drying the said crystals of Famotidine Polymorphs A and B combination in an oven.

19. The process as claimed in claim 18, wherein the crude Famotidine is prepared by an organic synthetic process.

20. The process as claimed in claim 18, wherein Famotidine Hydrochloride to solvent such as methanol ratio is 1:50 to 1:70.

21. The process as claimed in claim 18 wherein the Famotidine Hydrochloride-methanol solution with Activated carbon is filtered in Buchner funnel for obtaining clear colourless solution.

22. The process as claimed in claim 18, wherein the crystals of Famotidine Polymorphs A and B combination of the step (g) are dried in an oven at a temperature of 55 to 60 degrees centigrade.

23. The process as claimed in claim 18, wherein the ratio of Polymorph A to Polymorph B in the combination of Famotidine Polymorphs varies from 05:95 to 40:60.
